(19) United States
(12) Patent Application Publication
(10) Pub. No.: US 2019/0039612 A1
(43) Pub. Date: Feb. 7, 2019

(54) Technologies To Facilitate Automated Driving Assistance Based On Objects Sensed And Reported By Remote Senders

(71) Applicant: Intel Corporation, Santa Clara, CA (US)

(72) Inventors: Liuyang Lily Yang, Portland, OR (US); Manoj R. Sastry, Portland, OR (US); Xiruo Liu, Portland, OR (US); Moreno Ambrosin, Hillsboro, OR (US); Shabbir Ahmed, Beaverton, OR (US); Marcio Juliato, Portland, OR (US); Christopher N. Gutierrez, Hillsboro, OR (US)

(21) Appl. No.: 16/145,285

(22) Filed: Sep. 28, 2018

(51) Int. Cl. B60W 30/095; B60W 40/02; G01S 5/00

(52) U.S. Cl. CPC B60W 30/0953; B60W 30/0956; B60W 40/02; B60W 2550/10; B60W 2550/408; B60W 2750/308; G01S 5/0072

(57) ABSTRACT

In an automated method for providing driving assistance, an electronic control unit (ECU) of a first driving assistance system of a first vehicle receives local object information from at least one sensing component of the first driving assistance system. The first driving assistance system automatically detects external objects outside of the first vehicle, based on the local object information received from the at least one sensing component. The first driving assistance system also receives a reported object list (ROL) from a second vehicle, wherein the ROL describes objects detected by a second driving assistance system in the second vehicle. The first driving assistance system also affects operation of the first vehicle, based on (a) the external objects detected by the first vehicle and (b) the ROL from the second vehicle. Other embodiments are described and claimed.

### TECHNICAL FIELD

The present disclosure pertains in general to automated driving assistance systems and in particular to technologies to facilitate automated driving assistance based on objects that have been sensed and reported by remote senders.

### BACKGROUND

A vehicle may include a driving assistance system that includes an electronic control unit (ECU) and various sensors in communication with the ECU. Based on data from the sensors, the ECU senses objects around the vehicle and responds accordingly. For instance, in a subject vehicle with a driving assistance system that provides for adaptive cruise control, the ECU may monitor the distance between the subject vehicle and another vehicle in front of the subject vehicle, and the ECU may automatically reduce the speed of the subject vehicle if that distance becomes too small. Thus, a conventional driving assistance system may provide automated driving assistance for a vehicle based on objects sensed by that vehicle.

In addition, a conventional driving assistance system in a subject vehicle may broadcast messages to other vehicles, and each of those messages may describe certain characteristics of the subject vehicle, such as the current location, heading, speed, and acceleration of the subject vehicle. However, when other vehicles receive such messages, the content of those messages may not be reliable. For instance, if the driving assistance system of the subject vehicle has been compromised with malicious software (“malware”), the driving assistance system may broadcast false information to the other vehicles.

### BRIEF DESCRIPTION OF THE DRAWING

Features and advantages of the present invention will become apparent from the appended claims, the following detailed description of one or more example embodiments, and the corresponding figures, in which:

FIG. 1 is a block diagram of an example environment including a vehicle with a driving assistance system that includes technology to facilitate automated driving assistance based on objects that have been sensed and reported by remote senders.

FIG. 2 is a block diagram depicting an example embodiment of vehicle with a driving assistance system that includes technology to facilitate automated driving assistance based on objects that have been sensed and reported by remote senders.

FIGS. 3A through 3B present a flowchart of an example embodiment of a process to facilitate automated driving assistance based on objects that have been sensed and reported by remote senders.

FIG. 4 is a flow diagram depicting information flow within an example embodiment of a driving assistance system that includes technology to facilitate automated driving assistance based on objects that have been sensed and reported by remote senders.

### DETAILED DESCRIPTION

As indicated above, a conventional driving assistance system may provide automated driving assistance for a subject vehicle based on objects sensed by that vehicle. The driving assistance system may also broadcast messages to other vehicles, to describe certain characteristics of the subject vehicle. For instance, standards have been developed in the U.S. and in Europe calling for each vehicle to periodically send messages that describe the current location and speed of the sending vehicle. In the U.S., for example, on Jan. 12, 2017, the National Highway Traffic Safety Administration (NHTSA) of the U.S. Department of Transportation (DOT) published Federal Motor Vehicle Safety Standard (FMVSS) No. 150 (“FMVSS 150”) in the Notice of Proposed Rulemaking that starts on page 3854 of the Federal Register, Vol. 82, No. 8. FMVSS 150 proposes to mandate vehicle-to-vehicle (V2V) communications for new vehicles and to standardize the message and format of V2V transmissions. In particular, FMVSS 150 proposes to “require all new light vehicles to be capable of [V2V] communications, such that they will send and receive Basic Safety Messages” (BSMs) to and from other vehicles. In particular, FMVSS 150 “contains V2V communication performance requirements predicated on the use of on-board dedicated short-range radio communication (DSRC) devices to transmit [BSMs] about a vehicle's speed, heading, brake status, and other vehicle information to surrounding vehicles, and receive the same information from them.” FMVSS also mentions various standards, including standards from SAE International, such as the “Dedicated Short Range Communications (DSRC) Message Set Dictionary J2735_201603” (“SAE J2735”). More information on DSRC standards and on the related topics of wireless access in vehicular networks (WAVE) and Institute of Electrical and Electronics Engineers (IEEE) standards 1609.1/.2/.3/.4 may also be found in the article entitled “Notes on DSRC & WAVE Standards Suite: Its Architecture, Design, and Characteristics” by Y. L. Morgan in the publication IEEE Communications Surveys & Tutorials, Vol. 12, No. 4, Fourth Quarter 2010. Similarly, in Europe, the Intelligent Transport Systems (ITS) Committee of the European Telecommunications Standards Institute (ETSI) has promulgated European Standard (EN) 302 637-2, entitled “Specification of Cooperative Awareness Basic Service.” That standard provides for messages known as “Cooperative Awareness Messages” or “CAMs.” In particular, according to version 1.3.2 of EN 302 637-2, “Cooperative awareness [(CA)] means that road users and roadside infrastructure are informed about each other's position, dynamics and attributes. It is achieved by regular exchange of information among vehicles (V2V, in general all kind of road users) and between vehicles and road side infrastructure . . . based on wireless networks, called V2X network.”

For purposes of this disclosure, the following terms have the following meanings:
A “transportation safety network” (TSN) is a collection of two or more vehicles and zero or more stationary transportation facilities that have the ability to share (i.e., send and/or receive) messages pertaining to transportation safety with each other.
A “transportation safety message” (TSM) is a message pertaining to transportation safety that is communicated within a TSN network.
A “roadside unit” is a stationary transportation facility that has the ability to share TSMs.
A “TSN node” is a vehicle or a roadside unit with the ability to share TSMs within a TSN network.
A “facility/vehicle (F/V) message” is a TSM that is shared between a vehicle and a roadside unit.
A “vehicle/anything” (V/X) message” is a TSM that is shared between a vehicle and another vehicle or between a vehicle and a roadside unit.
A “detected object” is an object (a) that has been detected by a TSN node and (b) that is separate and distinct from that TSN node.
A “basic TSM” is a TSM from a TSN node that is structured in such a way as to enable the TSM to describe one or more attributes of that node, such as the node's location.
A “multi-object TSM” is TSM that is structured in such a way as to enable the TSM to describe (a) one or more attributes of a TSN node and (b) multiple detected objects that have been detected by that node.
A “detected object list” (DOL) is data in a TSN node that describes objects which have been detected by that node.
A “system object list” (SOL) is data in a TSN node, wherein (a) the data describes objects which are separate and distinct from that node and (b) the data has been accepted as trustworthy by that node.
A “reported object list” (ROL) is data that a TSN node includes in a TSM to describe objects which have (purportedly) been detected by that node.
   Also, an F/V message may be a vehicle-to-vehicle (V2V) message (i.e., a TSM that is sent from one vehicle to another), a vehicle-to-facility (V2F) message (i.e., a TSM that is sent from a vehicle to a roadside unit, or a facility-to-vehicle (F2V) message (i.e., a TSM that is sent from a roadside unit to a vehicle). Similarly, a V/X message may be a vehicle-to-anything (V2X) message (i.e., a TSM that is sent from a vehicle to another vehicle or to a roadside unit) or an anything-to-vehicle (X2V) message a TSM that is sent to a vehicle from another vehicle or from a roadside unit). A roadside unit may also be referred to as a stationary driving assistance facility.

Conventional standards such as FMVSS 150, SAE J2735, and EN 302 637-2 provide for basic TSMs. For instance, SAE J2735 prescribes a two part structure for BSMs, with “Part 1” listing various mandatory fields and “Part 2” listing various optional extensions. In particular, Part 1 is for “Basic Vehicle State,” and it lists the following mandatory fields:
MsgCount
TemporaryID
DSecond
Latitude
Longitude
Elevation
Positional Accuracy
TransmissionState
Speed
Heading
SteeringWheelAngle
AccelerationSet4Way
BrakeSystemStatus
VehicleSize.
   The fields in Part 1 may also be referred to as BSM core data. Part 2 is lists the following optional extensions:
VehicleSafetyExtensions
SpecialVehicleExtensions
SupplementalVehicleExtensions.
   The core data describes aspects or attributes of the subject vehicle, and it does not describe any objects detected by that vehicle.

By contrast, the present disclosure introduces multi-object TSMs. As indicated above, a multi-object TSM is structured in such a way as to enable the TSM to describe multiple objects. Those objects include the TSN node that generates the multi-object TSM, as well as the objects detected by that node. As indicated above, the data describing the detected objects may be referred to as a DOL. The DOL may identify various different types of objects, and it may describe various aspects or attributes for each detected object. For instant, the DOL may identify, the following types of objects, and others:
vehicles,
pedestrians,
cyclists,
other types of road users,
road signs, and
other relevant objects.
   Also, the described aspects or attributes for each detected object may include, without limitation, the location, speed, acceleration, heading, and size of the object. Thus, a DOL in the subject vehicle may include a list of other vehicles detected by the subject vehicle, a list of the other road users detected, a list of the road signs detected, etc. Additionally, as described in greater detail below, the subject vehicle may report its DOL to other vehicles as an ROL in a multi-object TSM. Such TSMs may follow a standard that defines some or all of the object types for classifying each detected object and that requires each TSM to describe a certain set of attributes for each detected object, such as some or all of the attributes mentioned above.

In addition, the standard may require each TSM to include descriptions only for objects detected by the sender. Alternative, the standard may allow or require each TSM to also include descriptions for objects reported to the sender by other nodes; and the standard may require the TSM to indicate, for each object, whether that object was (a) detected by the sender, (b) reported to the sender by another node, or (c) both detected by the sender and reported to the sender by another node. In addition or alternatively, the standard may require each object description to include a numerical confidence score.

TSN nodes typically communicate via at least one wireless link. A sender of a TSM may include a digital certificate in the TSM to provide for security. The recipient of a TSM with a digital certificate may use the digital certificate to verify the authenticity and integrity of the message. In other words, the recipient may use the digital certificate (a) to verify the identity of the sender and (b) to determine whether or not the message was modified in transit.

However, digital certificates alone are not sufficient to guarantee the reliability of the data in TSMs. For instance, the source of the data (e.g., the sender) could be compromised by malware, or the source could be an attacker that has obtained a digital certificate and that then uses that digital certificate in TSMs with false data. In a conventional TSN, a TSM with a valid certificate but false data may be taken as legitimate by the receiving nodes. Consequently, it may be dangerous for vehicles to rely TSMs from other nodes, as those TSMs may contain false information.

As indicated above, the present disclosure describes technology to facilitate automated driving assistance based on objects that have been sensed and reported by remote senders. This technology may be promoted, for instance, by modifying standards for TSMs to allow for or to require multi-object TSMs which include locally sourced observations about other objects within the perception range of the transmitting car. In addition, the present disclosure describes technology for determining, at a recipient node, whether the data in TSMs from other nodes is trustworthy. For instance, the present disclosure describes a mechanism to determine a confidence level for the data received from TSMs sent by multiple independent sources. For example, as described in greater detail below, a driving assistance system in a vehicle may process object lists received within TSMs from multiple independent sources and assign a confidence score to each of the objects, with the confidence score reflecting the degree of consistency of the object's information across multiple independent TSMs. The driving assistance system then uses the confidence score to filter out spoofed or erroneous data. The driving assistance system thus determines whether the data in received TSMs are trustworthy, to prevent rogue senders from fooling the subject vehicle into taking unsafe actions.

In particular, as described in greater detail below, a driving assistance system in a subject vehicle may enable that vehicle to participate in a TSN by receiving TSMs from other nodes in the TSN. Those other nodes (remote senders) may include other vehicles, as well as stationary structures such as roadside units. Those TSMs may describe objects sensed by the remote senders. The driving assistance system that receives those TSMs may then provide automated driving assistance for the subject vehicle, based on the objects reported by the remote senders. Likewise, the driving assistance system in the subject vehicle may send reports to other vehicles in the TSN to describe objects sensed by the subject vehicle. Driving assistance systems in the other vehicles may provide driving assistance for those vehicles based on the objects reported by the subject vehicle.

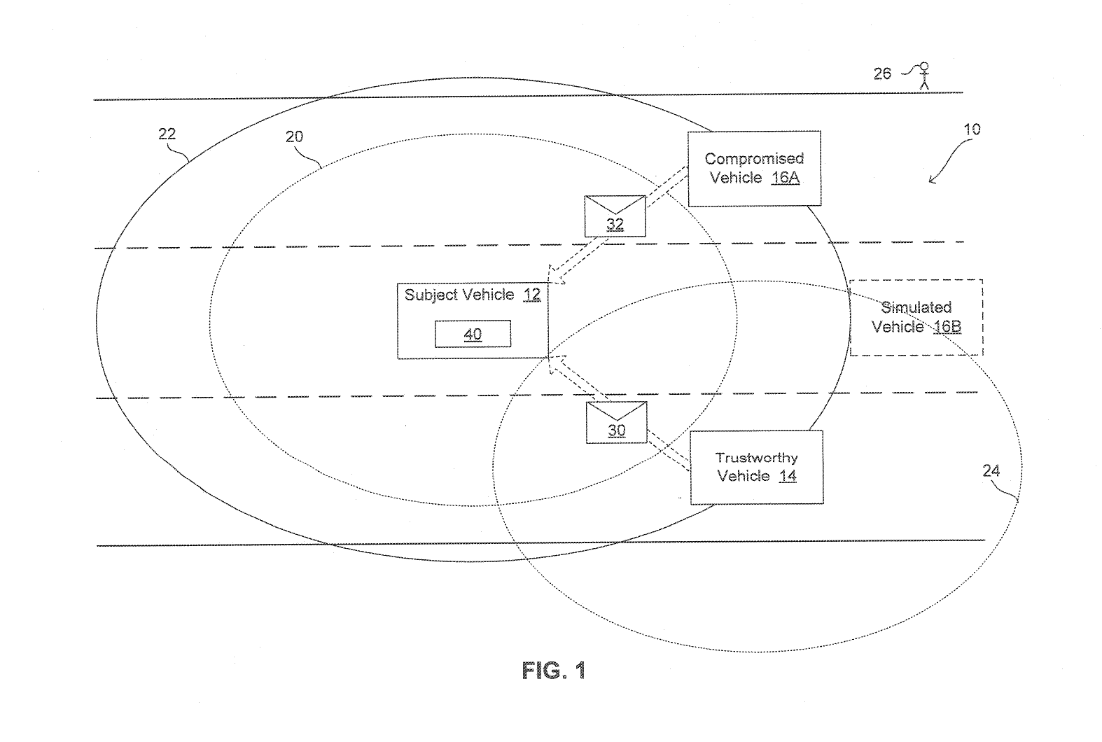

FIG. 1 is a block diagram of an example environment 10 including a subject vehicle 12 with a driving assistance system 40 that includes technology to facilitate automated driving assistance based on objects that have been sensed and reported by remote senders. In FIG. 1, the remote senders include a trustworthy vehicle 14 and a compromised vehicle 16A, each of which also includes a driving assistance system that enables those vehicles to share TSMs with subject vehicle 12. Accordingly, environment 10 may also be referred to as a TSN 10.

FIG. 1 depict a scenario in which the vehicles are traveling from left to right on a road that includes a left lane, a middle lane, and a right lane. Driving assistance system 40 in subject vehicle 12 includes sensors for detecting objects around subject vehicle 12. Those sensors give subject vehicle 12 a limited sensing range or object detection range 20. The object detection range of a vehicle may also be referred to as the surveillance area of the vehicle. Driving assistance system 40 is also able to receive TSMs from other vehicles within a network range 22. In the scenario of FIG. 1, trustworthy vehicle 14 and compromised vehicle 16A are outside of object detection range 20 but within network range 22. Compromised vehicle 16A and trustworthy vehicle 14 also include driving assistance systems.

Also, in the illustrated scenario, the driving assistance system in compromised vehicle 16A has been infected with malware which causes compromised vehicle 16A to include false data in its TSMs. In particular, compromised vehicle 16A sends a multi-object TSM 32 to subject vehicle 12, and TSM 32 falsely reports that compromised vehicle 16A has detected another vehicle in the middle lane, in the location depicted as simulated vehicle 16B. In other words, compromised vehicle 16A falsely report the existence of and position of simulated vehicle 16B. Also, in the illustrated scenario, simulated vehicle 16B is reported as being outside of object detection range 20 and outside of network range 22 of subject vehicle 12. However, the object detection range 24 for trustworthy vehicle 14 encompasses at least part of the space purportedly occupied by simulated vehicle 16B.

In another scenario, the TSM that compromised vehicle 16A sends to subject vehicle 12 is a basic TSM that falsely reports they location of compromised vehicle 16A as being in the middle lane, in the location depicted as simulated vehicle 16B. In other words, compromised vehicle 16A may, in effect, represent itself as being simulated vehicle 16B.

If driving assistance system 40 were to treat either of those TSMs from compromised vehicle 16A as trustworthy, driving assistance system 40 might adversely affect the operation of subject vehicle 12, based on the falsely reported existence and location of simulated vehicle 16B. However, as described in greater detail below, driving assistance system 40 includes technology for determining whether or not the data from compromised vehicle 16A (and from other nodes) is trustworthy.

Figure also depicts trustworthy vehicle 14 sending a TSM 30 to subject vehicle 12. TSM 30 includes data describing the location, speed, and heading of trustworthy vehicle 14. As described in greater detail below, TSM 30 may also include additional data, preferably including data describing objects detected by trustworthy vehicle 14. Accordingly, as described in greater detail below, TSM 30 may enable subject vehicle 12 to determine whether or not the data from compromised vehicle 16A is trustworthy.

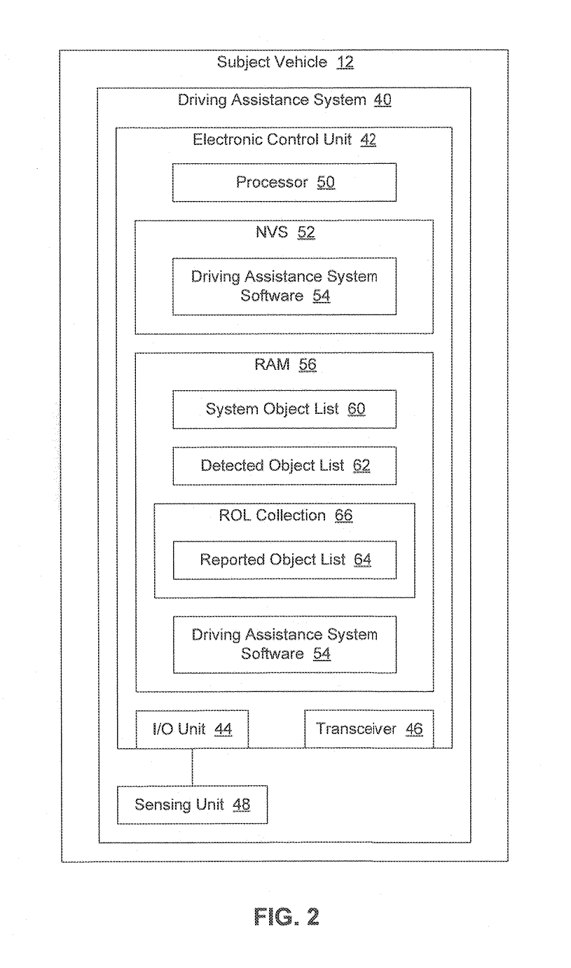

FIG. 2 is a block diagram depicting driving assistance system 40 in subject vehicle 12 in greater detail. As illustrated, driving assistance system 40 includes an electronic control unit (ECU) 42 and at least one sensing unit 48 (e.g., a camera, a radar unit, a lidar unit, a global positioning system (GPS) unit, etc.). ECU 42 includes at least one processor 50, nonvolatile storage (NVS) 52, random access memory (RAM) 56, at least one input/output (I/O) unit 44 (e.g., an I/O port), and a transceiver 46. I/O unit 44 enables ECU 42 to receive data from sensing unit 48. Transceiver 46 enables ECU 42 to send TSMs to and receive TSMs from other TSN nodes.

NVS 52 includes driving assistance system software 54. ECU 42 may copy driving assistance system software 54 from NVS 52 into RAM 56 for execution. As described in greater detail below, when driving assistance system software 54 is executing, driving assistance system software may create, obtain, and/or use a system object list (SOL) 60, a detected object list (DOL) 62, and a reported object list (ROL) 64. In fact, driving assistance system 40 may receive reported object lists from multiple other nodes, and driving assistance system 40 may accumulate those reported object lists into an ROL collection 66.

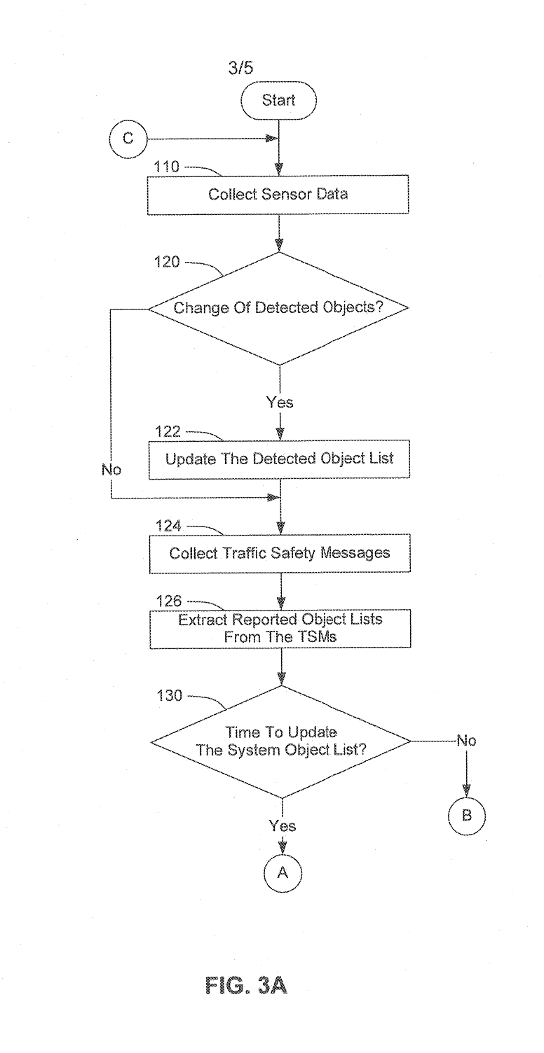

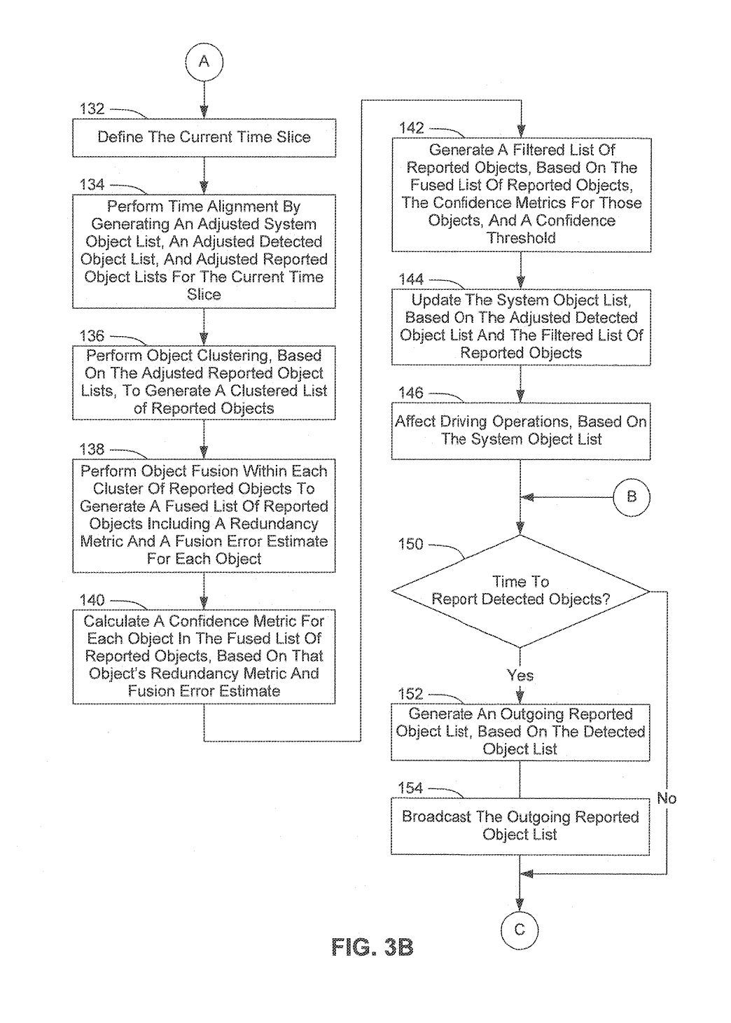

FIGS. 3A through 3B present a flowchart of all example embodiment of a process to facilitate automated driving assistance based on objects that have been sensed and reported by remote senders. In particular, FIGS. 3A through 3B present that process with regard to the scenario illustrated in FIG. 1, primarily from the perspective of subject vehicle 12. The illustrated process starts with driving assistance system 40 collecting sensor data from sensing unit 48, as shown at block 110. As shown at block 120, driving assistance system 40 may then determine whether there has been any change with regard to the objects sensed around subject vehicle 12, based on the collected sensor data. For instance, driving assistance system 40 may determine whether a new object has been detected or whether an object that was previously detected has changed position or left the detection range. If any such change is detected, driving assistance system 40 may update DOL 62 accordingly, as shown at block 122.

As shown at block 124, driving assistance system 40 may also receive and collect TSMs from other TSN nodes. In one scenario, the nodes in the TSN follow a standard that allows for basic TSMs and for multi-object TSMs. In another scenario, the nodes in the TSN follow a standard that requires all TSMs to be multi-object TSMs. As indicated above, each TSM includes data describing attributes of the sending node, and each multi-object TSM also includes data describing objects detected by the sending node. As indicated above, the data in a multi-object TSM that describes objects detected by the sending node may be referred to as an ROL.

As shown at block 126, driving assistance system 40 may extract the ROL from each multi-object TSM it receives, and driving assistance system 40 may save each extracted ROL to ROL collection 66. As described in greater detail below, driving assistance system 40 may then use the ROLs in ROL collection 66, together with other data, to make decisions affecting the operation of subject vehicle 12.

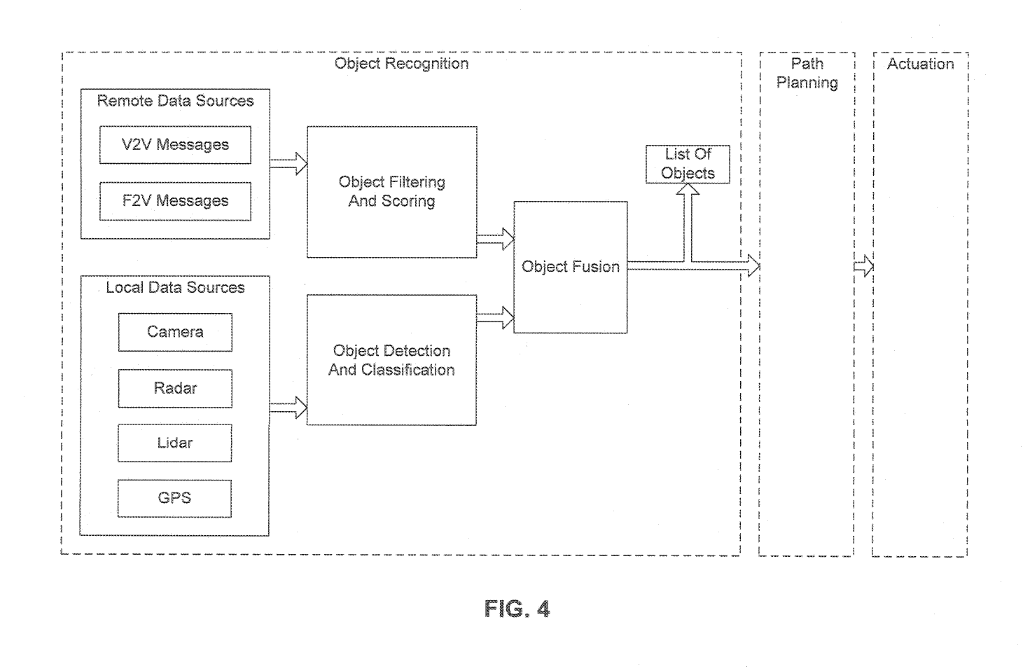

FIG. 4 is a flow diagram depicting information flow within an example embodiment of a driving assistance system that includes technology to facilitate automated driving assistance based on objects that have been sensed and reported by remote senders. Driving assistance system 40, for example, may process data according to the flow illustrated in FIG. 4. In particular, as illustrated, the process of providing automated driving assistance may include three different phases: an object recognition phase, a path planning phase, and an actuation phase.

In the object recognition phase, driving assistance system 40 may collect data from local data sources, such as sensing unit 48 and from remote data sources, such as other nodes in TSN 10. As indicated above, sensing unit 48 represents sensing components such a camera, etc. The data from remote data sources may include TSMs from other vehicles (i.e., V2V messages) and TSMs from roadside units (i.e., F2V messages). As described in greater detail below, driving assistance system 40 may then process the data from remote sources using object scoring and filtering, and driving assistance system 40 may process the data from local sources using object detection and classification. Driving assistance system 40 may then use object fusion to merge or combine those results into a unified list of objects. For instance, as described in greater detail below, in the object fusion stage, driving assistance system 40 may reject data from one node that describes an object purportedly detected by that node, based on inconsistent or contrary data from one or more other nodes. In one embodiment, SOL 60 is the unified list of objects that is produced using object fusion. Driving assistance system 40 may then use SOL 60 for the path planning and actuation phases.

Referring again to FIG. 3A, in the illustrated process, driving assistance system 40 periodically update SOL 60 according to a predetermined time interval, so that any driving assistance operations that driving assistance system performs to affect operation of subject vehicle 12 are based on fresh data. In one embodiment or scenario, that update interval is a fraction of a second, such as a tenth of a second; however, other update intervals may be used on other embodiments or scenarios.

Accordingly, block 130 shows that driving assistance system 40 determines whether it is time to update SOL 60. If it is time, the process passes through page connect A to block 132 of FIG. 3B. As shown at block 132, driving assistance system 40 then defines the current time slice. For instance, if the update interval is 0.1 seconds, the last update occurred at second 50.1, and it is now 50.2, driving assistance system 40 may define the time slice as the period from 50.1 to 50.2.

As shown at block 134, driving assistance system 40 then performs time alignment for the objects described in SOL 60, DOL 62, and ROL collection 66 by generating an adjusted SOL, an adjusted DOL, and adjusted ROLs for the current time slice. In particular, driving assistance system 40 determines or predicts the current state of the objects in those lists, and saves data describing the predicted current state in the adjusted lists. For each object, the prediction of the current state is based on factors such as (a) how much time has elapsed (relative to the current time) since the object was last reported, (b) where was the object when it was last reported, (c) what were the speed and acceleration of the object when it was last reported, (d) what was the heading of the object when it was last reported, etc.

The ROLS in ROL collection 66 for the current time slice may be referred to as a snapshot. As part of time alignment, driving assistance system 40 may create an adjusted ROL for each ROL in ROL collection 66 that falls within the current time slice or snapshot. However, if the current time slice includes a sequence of ROLs from the same node, driving assistance system 40 may either drop all but the most current ROL from that sequence or consolidate that sequence of ROLs into one adjusted ROL, to prevent an individual sending node from having inordinate influence.

Driving assistance system 40 may use any suitable technique or combination of techniques to generate the adjusted SOL, the adjusted DOL, and the adjusted ROLs. For instance, in one embodiment or scenario, driving assistance system 40 may use data synchronization techniques such as those described in the article from June of 2012 entitled “A Track-To-Track Association Method for Automotive Perception Systems” by Adam Houenou et al. from the IEEE Intelligent Vehicle Symposium (IV 2012) (hereinafter “the Track-to-Track report”).

Then, as shown at block 136, to determine whether reported objects from different ROLs likely refer to the same physical object, driving assistance system 40 performs object clustering, based on the adjusted ROLs, to generate a clustered list of reported objects. In other words, driving assistance system 40 uses object clustering over the adjusted ROLs to associate reported objects with physical objects. For instance, if ROL collection 66 includes multiple different ROLs from multiple different nodes, the object clustering operation generates a unified list of reported objects (i.e., the clustered list of reported objects), based on the adjusted ROLs. Thus, driving assistance system 40 groups similar reported objects, for subsequent fusion. Driving assistance system 40 may use any suitable technique or combination of techniques to perform object clustering, including without limitation techniques such as those described in the Track-to-Track report.

As shown at block 138, driving assistance system 40 then performs object fusion within each cluster of reported objects to generate a fused list of reported objects. That list includes a redundancy metric and a fusion error estimate for each object. The redundancy metric indicates how many different nodes or independent sources reported that object.

The fusion error estimate for a fused object is based on the error metrics for the objects that were fused. And the error metric for an object is based on the perception abilities of the sensing unit(s) that sensed the object and on the actual data collected by the sensing unit(s). For instance, when driving assistance system 40 detects an object based on data from a depth camera, the data for that object in DOL 62 may include (a) a value to describe the distance from subject vehicle 12 to that object and (b) an error metric to indicate an expected degree of accuracy or precision for the distance value. Such error metrics propagate to the fusion error metric.

In one embodiment or scenario, driving assistance system 40 uses an integer for the redundancy metric and a value between 0 and 1 for the fusion error estimate. However, other types of values may be used in other embodiments or scenarios. For instance, a driving assistance system may use a covariance matrix for the fusion error estimate for an object, instead of a single value. Such a covariance matrix may be referred to as an error covariance matrix. In addition or alternatively, a driving assistance system may derive the fusion error estimate as a value between 0 and 1, based on an error covariance matrix.

Driving assistance system 40 may use any suitable technique or combination of techniques to generate the fused list of reported objects. For instance, driving assistance system 40 may use a covariance intersection (CI) algorithm to determine whether reported objects should be combined, based on the error covariance matrixes for those objects. As shown at block 140, driving assistance system 40 then calculates a confidence metric for each object in the fused list of reported objects, based on that object's redundancy metric and fusion error estimate. For instance, in one embodiment or scenario, the confidence metric is a number within the range from 0 to 1, and the calculation algorithm uses as input the redundancy metric and the fusion error estimate, which is a metric that reflects the degree of consistency of the object across multiple sources. In addition, if driving assistance system 40 has previously computed one or more confidence metrics for the object, the algorithm also uses the last N confidence metrics for the object when computing the current confidence metric. Driving assistance system 40 may use any suitable formula to compute the current confidence metric based on the redundancy metric, the fusion error estimate, and the previous confidence metrics (if any). For example, the formula may use concepts from the recommendation systems literature, and the existence of an object may be interpreted as an opinion expressed by an independent entity; the more the opinions on the same object, the higher will be the confidence in that object.

As shown at block 142, driving assistance system 40 then generates a filtered list of reported objects, based on the fused list of reported objects, the confidence metrics for those objects, and a confidence threshold. For instance, in one embodiment or scenario, driving assistance system 40 uses a confidence threshold of 0.9. Consequently, when generating the filtered list of reported objects, driving assistance system 40 will include each object with a confidence metric of at least 0.9 and reject each object with a confidence metric less than 0.9. Additionally, driving assistance system 40 may compute the current confidence metric for each object using a formula that generates a result of less than 0.9 if an object is not detected by at least two nodes. For instance, if an object has been reported by only one remote node, and that object has not been detected by subject vehicle 12, the formula or algorithm for computing confidence metrics may generate a result of less than 0.9 for that object. Consequently, driving assistance system 40 may omit that object from the filtered list of reported objects. Consequently, when updating the SOL (as described in greater detail below), driving assistance system 40 will not add that object to the SOL. Thus, driving assistance system filters out reported objects from rogue nodes.

For instance, in the scenario depicted in FIG. 1, subject vehicle 12 receives a multi-object TSM from compromised vehicle 16A that reports an object (e.g., a vehicle) detected in the position illustrated as simulated vehicle 16B. In addition, subject vehicle 12 receives a multi-object TSM from trustworthy vehicle 14 that reports no objects detected in the position illustrated as simulated vehicle 16B. In such a scenario, if the confidence threshold is 0.9, driving assistance system 40 may calculate the confidence metric for simulated vehicle 16B to be less than 0.9. Consequently, driving assistance system 40 will not include simulated vehicle 16B in the filtered list of reported objects.

Referring again to FIG. 3B, after generating the filtered list of reported objects, driving assistance system 40 then updates SOL 60, based on the adjusted DOL and the filtered list of reported objects. For instance, if the adjusted DOL and the filtered list of reported objects agree that a new object has been detected, driving assistance system 40 may add that object to the SOL 60. Thus, driving assistance system 40 may merge the adjusted DOL and the filtered list of reported objects into SOL 60. At this point driving assistance system 40 may also remove stale objects from SOL 60. For instance, driving assistance system 40 may implement a track/object management policy that causes driving assistance system 40 to remove every object in SOL 60 that hasn't been updated for the last M rounds.

As shown at block 146, driving assistance system 40 then affects driving operations, based on updated SOL 60. In particular, referring again to FIG. 4, driving assistance system 40 may execute both the path planning phase and the actuation phase, based on (updated) SOL 60.

For instance, if subject vehicle 12 has a driver who is using adaptive cruise control, driving assistance system 40 may automatically reduce the speed of subject vehicle 12 based on data from SOL 60 indicating that there is a vehicle within a certain distance ahead of subject vehicle 12. As another example, if subject vehicle 12 has a driver and SOL 60 indicates that there is debris on the road ahead, driving assistance system 40 may sound a warning beep and display a suitable visual warning for the driver to see. As another example, if subject vehicle 12 is operating autonomously, driving assistance system 40 may automatically adjust the speed and/or direction of subject vehicle 12, based on SOL 60.

Driving assistance system 40 may also periodically broadcast multi-object TSMs to other nodes in TSN 10 according to a predetermined time interval. Accordingly, as shown at block 150 of FIG. 3B, driving assistance system 40 may determine whether it is time to report the objects detected by subject vehicle 12 to other nodes. Driving assistance system 40 may make such a determination at any suitable stage of the process. For instance, as indicated by page connector B, driving assistance system 40 may make such a determination after determining at block 130 that it is not yet time to update SOL 60. In addition or alternatively, driving assistance system 40 may make such a determination after updating SOL 60 and affecting driving operations, as shown at block 144 and 146. If it is not yet time to report detected objects, the process may return to block 110 through page connector C, and driving assistance system 40 may continue to collect sensor data, etc., as indicated above.

However, if it is time to report detected objects, driving assistance system 40 may generate an outgoing ROL, based on DOL 62, as shown at block 152. For instance, driving assistance system 40 may create a multi-object TSM with an ROL that describes all of the objects in DOL 62. As shown at block 154, driving assistance system 40 may then broadcast that multi-object TSM to the other nodes in TSN 10. The process may then return to block 110 through page connector C, and driving assistance system 40 may continue to collect sensor data, etc., as indicated above.

As has been described, a TSN includes vehicles with driving assistance systems that share multi-object TSMs, and the driving assistance systems use those multi-object TSMs to detect and filter out false information from malfunctioning or rogue senders. Such driving assistance systems may provide for greater safety and reliability, compared to driving assistance systems which do not use multi-object TSMs. Thus, multi-object TSMs may allow autonomous systems, for instance, to make decisions based on a higher degree of redundancy, thereby increasing security and the overall system safety. Each participating vehicle may use multi-object TSMs to inform other vehicles not only about that subject vehicle itself but also about objects perceived in the environment by the subject vehicle from the perspective of the subject vehicle. When an object is detected and reported by multiple participants, the credibility of that information dramatically increases. Accordingly, as indicated above, vehicles can cross-check information from multiple sources, and derive confidence scores based on the received information. For instance, referring again to FIG. 1, despite receiving information about simulated vehicle 16B from compromised vehicle 16A, subject vehicle 12 finds no correspondence in the timestamped ROL sent by trustworthy vehicle 14 in TSM 30. And if additional vehicles were present, subject vehicle 12 would finds no correspondence in the timestamped ROLs sent by those vehicles. Consequently, subject vehicle 12 will assign a low confidence score to the information received from compromised vehicle 16A, which will lead to subject vehicle 12 filtering out that information before performing path planning and actuation activities.

In addition, multi-object TSMs facilitate more precise and fault tolerant identification of obstacles which are outside of the perception range of a subject vehicle. For instance, with regard to FIG. 1, if subject vehicle 12 receives TSMs from two or more vehicles (e.g., compromised vehicle 16A and trustworthy vehicle 14) and each of those TSMs agrees that a pedestrian 26 has been detected at the same location, subject vehicle 12 can be relatively confident that there is a pedestrian at that location, even though that location is outside of object detection range 20.

Although certain example embodiments are described herein, one of ordinary skill in the art will understand that those example embodiments may easily be divided, combined, or otherwise altered to implement additional embodiments. For instance, according to the process described above, a driving assistance system processes its ROL collection on a periodic basis; but in an alternative embodiment, the driving assistance system may process each ROL as it is received. Also, the above description focuses on a driving assistance system in a subject vehicle. However, a roadside unit may perform the same or similar types of operations. A TSN may thereby leverage the broader coverage and the extended sensing capabilities that may be provided by stationary transportation facilities. For instance, a subject roadside unit may generate an ROL collection based on multi-object TSMs received from vehicles and/or other roadside units within network range of the subject roadside unit. Moreover, that network range may be global, since a roadside unit may include wireless and wired networking connectivity, with access, for example, to the Internet. The roadside unit may then process the ROLs using techniques such as those described above. For instance, the roadside unit may match reported objects with objects detected by the roadside unit using its perception layer (e.g., cameras and/or radars deployed on highways and/or at intersections), and the roadside unit may filter out objects with a low confidence metric. The roadside unit may then broadcast (with a tunable periodicity) the whole list of high-confidence objects detected under the coverage of that roadside unit. In addition or alternatively, in one embodiment, vehicles only include directly detected objects in their TSMs, while roadside unit include both directly detected objects and reported objects that have a sufficiently high confidence metric.

In the present disclosure, expressions such as “an embodiment,” “one embodiment,” and “another embodiment” are meant to generally reference embodiment possibilities. Those expressions are not intended to limit the invention to particular embodiment configurations. As used herein, those expressions may reference the same embodiment or different embodiments, and those embodiments are combinable into other embodiments. In light of the principles and example embodiments described and illustrated herein, it will be recognized that the illustrated embodiments can be modified in arrangement and detail without departing from such principles.

Also, as described above, a device may include instructions and other data which, when accessed by a processor, cause the device to perform particular operations. For purposes of this disclosure, instructions which cause a device to perform operations may be referred to in general as software. Software and the like may also be referred to as control logic. Software that is used during a boot process may be referred to as firmware. Software that is stored in nonvolatile memory may also be referred to as firmware. Software may be organized using any suitable structure or combination of structures. Accordingly, terms like program and module may be used in general to cover a broad range of software constructs, including without limitation application programs, subprograms, routines, functions, procedures, drivers, libraries, data structures, processes, microcode, and other types of software components. Also, it should be understood that a software module may include more than one component, and those components may cooperate to complete the operations of the module. Also, the operations which the software causes a device to perform may include creating an operating context, instantiating a particular data structure, etc. Any suitable operating environment and programming language (or combination of operating environments and programming languages) may be used to implement software components described herein.

A medium which contains data and which allows another component to obtain that data may be referred to as a machine-accessible medium or a machine-readable medium. In one embodiment, software for multiple components is stored in one machine-readable medium. In other embodiments, two or more machine-readable media may be used to store the software for one or more components. For instance, instructions for one component may be stored in one medium, and instructions another component may be stored in another medium. Or a portion of the instructions for one component may be stored in one medium, and the rest of the instructions for that component (as well instructions for other components), may be stored in one or more other media. Similarly, software that is described above as residing on a particular device in one embodiment may, in other embodiments, reside on one or more other devices. For instance, in a distributed environment, some software may be stored locally, and some may be stored remotely. Similarly, operations that are described above as being performed on one particular device in one embodiment may, in other embodiments, be performed by one or more other devices.

Accordingly, alternative embodiments include machine-readable media containing instructions for performing the operations described herein. Such media may be referred to in general as apparatus and in particular as program products. Such media may include, without limitation, tangible non-transitory storage components such as magnetic disks, optical disks, dynamic RAM, static RAM, read-only memory (ROM), etc., as well as processors, controllers, and other components that include data storage facilities. For purposes of this disclosure, the term “ROM” may be used in general to refer to nonvolatile memory devices such as erasable programmable ROM (EPROM), electrically erasable programmable ROM (EEPROM), flash ROM, flash memory, etc.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. In some embodiments, some or all of the control logic for implementing the described operations may be implemented in hardware logic (e.g., as microcode in an integrated circuit chip, as a programmable gate array (PGA), as an application-specific integrated circuit (ASIC), etc.).

Additionally, the present teachings may be used to advantage in many different kinds of data processing systems. Such data processing systems may include, without limitation, accelerators, systems on a chip (SOCs), wearable devices, handheld devices, smartphones, telephones, entertainment devices such as audio devices, video devices, audio/video devices (e.g., televisions and set-top boxes), vehicular processing systems, personal digital assistants (PDAs), tablet computers, laptop computers, portable computers, personal computers (PCs), workstations, servers, client-server systems, distributed computing systems, supercomputers, high-performance computing systems, computing clusters, mainframe computers, mini-computers, and other devices for processing or transmitting information. Accordingly, unless explicitly specified otherwise or required by the context, references to any particular type of data processing system (e.g., a PC) should be understood as encompassing other types of data processing systems, as well. A data processing system may also be referred to as an apparatus. The components of a data processing system may also be referred to as apparatus.

Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, ASICs, embedded computers, smart cards, and the like. For purposes of this disclosure, the term “bus” includes pathways that may be shared by more than two devices, as well as point-to-point pathways. Similarly, terms such as “line,” “pin,” etc. should be understood as referring to a wire, a set of wires, or any other suitable conductor or set of conductors. For instance, a bus may include one or more serial links, a serial link may include one or more lanes, a lane may be composed of one or more differential signaling pairs, and the changing characteristics of the electricity that those conductors are carrying may be referred to as signals on a line. Also, for purpose of this disclosure, the term “processor” denotes a hardware component that is capable of executing software. For instance, a processor may be implemented as a central processing unit (CPU), a processing core, or as any other suitable type of processing element. A CPU may include one or more processing cores, and a device may include one or more CPUs.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

What is claimed is:

1. An electronic control unit (ECU) for a driving assistance system for a vehicle, the ECU comprising:
a processor;
an input/output (I/O) unit responsive to the processor, the I/O unit to enable the processor to receive local object information from one or more sensing components when the ECU is installed in a first vehicle with the one or more sensing components to form at least part of a first driving assistance system;
a transceiver responsive to the processor, the transceiver to enable the processor to receive reported object lists (ROLs) from remote data processing systems;
a machine-readable medium responsive to the processor; and
instructions in the machine-readable medium which, when executed by the processor, enable the ECU to:
detect external objects outside of the first vehicle, based on the local object information from the one or more sensing components;
receive an ROL from a second vehicle, wherein the ROL describes objects detected by a second driving assistance system in the second vehicle; and
affect operation of the first vehicle, based on (a) the external objects detected by the first vehicle and (b) the ROL from the second vehicle.

2. An ECU according to claim 1, wherein the instructions, when executed by the processor, enable the ECU in the first vehicle to:
generate a detected object list (DOL) in the first driving assistance system, wherein the DOL describes the external objects detected, based on the local object information from the one or more sensing components;
update a system object list (SOL) in the first driving assistance system, based on (a) the in the first driving assistance system and (b) the ROL from the second vehicle; and
affect operation of the vehicle, based on the SOL.

3. An ECU according to claim 2, wherein the operation of updating the SOL, based on the DOL and the ROL, comprises:
determining whether a particular object described in the ROL has also been detected by the first driving assistance system; and
if that particular object has not been detected by the first driving assistance system, including that particular object in the SOL only if that particular object is also described in an ROL from at least one additional remote data processing system.

4. An ECU according to claim 2, wherein:
the ROL comprises an incoming ROL; and
the instructions, when executed, further enable the first driving assistance system in the first vehicle to:
generate an outgoing ROL, based at least in part on the DOL, wherein the outgoing ROL describes the external objects detected by the first driving assistance system in the first vehicle; and
send the outgoing ROL from the first driving assistance system in the first vehicle to the second driving assistance system in the second vehicle.

5. An ECU according to claim 4, wherein the instructions, when executed, further enable the first driving assistance system in the first vehicle to:
receive incoming ROLs from multiple vehicles other than the first vehicle; and
update the SOL, based on the DOL from the first vehicle and on the multiple incoming ROLs.

6. An ECU according to claim 1, wherein the instructions in the machine-readable medium, when executed by the processor, further enable the ECU to:
receive and process ROLs from stationary driving assistance facilities, said ROLs describing objects detected by said stationary driving assistance facilities.

7. A driving assistance system for a vehicle, the driving assistance system comprising:
an ECU according to claim 1; and
at least one sensing component according to claim 1.

8. An apparatus with control logic for a driving assistance system, the apparatus comprising:
a non-transitory machine-readable medium; and
instructions in the machine-readable medium which, when executed by an electronic control unit (ECU) in a first driving assistance system in a first vehicle, enable the first driving assistance system to:
detect external objects outside of the first vehicle, based on local object information received from at least one sensing component in the first driving assistance system;
receive an ROL from a second vehicle, wherein the ROL describes objects detected by a second driving assistance system in the second vehicle; and
affect operation of the first vehicle, based on (a) the external objects detected by the first vehicle and (b) the ROL from the second vehicle.

9. An apparatus according to claim 8, wherein the instructions, when executed by the ECU, enable the first driving assistance system to:
generate a detected object list (DOL) in the first driving assistance system, wherein the DOL describes the external objects detected, based on the local object information received from the one or more sensing components;
update a system object list (SOL) in the first driving assistance system, based on (a) the DOL in the first driving assistance system and (b) the ROL from the second vehicle; and
affect operation of the vehicle, based on the SOL.

10. An apparatus according to claim 9, wherein the operation of updating the SOL, based on the DOL and the ROL, comprises:
determining whether a particular object described in the ROL has also been detected the first driving assistance system; and
if that particular object has not been detected by the first driving assistance system, including that particular object in the SOL only if that particular object is also described in an ROL from at least one additional remote data processing system.

11. An apparatus according to claim 9, wherein:
the ROL comprises an incoming ROL; and
the instructions, when executed, further enable the driving assistance system in the first vehicle to:
generate an outgoing ROL, based at least in part on the DOL, wherein the outgoing ROL describes the external objects detected by the first driving assistance system in the first vehicle; and
send the outgoing ROL from the first driving assistance system in the first vehicle to the second driving assistance system in the second vehicle.

12. An apparatus according to claim 11, wherein the instructions, when executed, further enable the first driving assistance system in the first vehicle to:
receive incoming ROLs from multiple vehicles other than the first vehicle; and
update the SOL, based on the DOL from the first vehicle and on the multiple incoming ROLs.

13. An apparatus according to claim 9, wherein the DOL comprises a first DOL, the ROL comprises a first ROL, the SOL comprises a first set of data, and the instructions, when executed by the processor, enable to processor to:
after receiving the first ROL, generating the first DOL and updating the SOL, (a) receive a second ROL, (b) generate a second DOL, and (c) update the SOL with a second set of data, based on the second ROL, the second DOL, and the first set of data from the SOL.

14. An apparatus according to claim 8, wherein the instructions in the machine-readable medium, when executed by the processor, further enable the ECU to:
receive and process ROLs from stationary driving assistance facilities, said ROLs describing objects detected by said stationary driving assistance facilities.

15. An automated method for providing driving assistance, the method comprising:
receiving, at an electronic control unit (ECU) of a first driving assistance system of a first vehicle, local object information from at least one sensing component of the first driving assistance system;
automatically detecting external objects outside of the first vehicle, based on the local object information received from the at least one sensing component;
receiving a reported object list (ROL) from a second vehicle, wherein the ROL describes objects detected by a second driving assistance system in the second vehicle; and
affecting operation of the first vehicle, based on (a) the external objects detected by the first vehicle and (b) the ROL from the second vehicle.

16. A method according to claim 15, further comprising:
generating a detected object list (DOL) in the first driving assistance system, wherein the DOL describes the external objects detected, based on the local object information received from the one or more sensing components;
updating a system object list (SOL) in the first driving assistance system, based on (a) the DOL in the first driving assistance system and (b) the ROL from the second vehicle; and
affecting operation of the vehicle, based on the SOL.

17. A method according to claim 16, wherein the operation of updating the SOL, based on the DOL and the ROL, comprises:
determining whether a particular object described in the ROL has also been detected by the first driving assistance system; and
if that particular object has not been detected by the first driving assistance system, including that particular object in the SOL only if that particular object is also described in an ROL from at least one additional remote data processing system.

18. A method according to claim 6, wherein the ROL comprises an incoming ROL, and the method further comprises:
generating an outgoing ROL, based at least in part on the DOL, wherein the outgoing ROL describes the external objects detected by the first driving assistance system in the first vehicle; and
sending the outgoing ROL from the first driving assistance system in the first vehicle to the second driving assistance system in the second vehicle.

19. A method according to claim 16, further comprising:
receiving incoming ROLs from multiple vehicles other than the first vehicle; and
updating the SOL, based on the DOL from the first vehicle and on the multiple incoming ROLs.

20. A method according to claim 15, further comprising:
receiving and processing ROLs from stationary driving assistance facilities, said ROLs describing objects detected by said stationary driving assistance facilities.
